(19) United States
(12) Patent Application Publication
(10) Pub. No.: US 2010/0076899 A1
(43) Pub. Date: Mar. 25, 2010

(54) METHOD FOR MANAGING A TRANSITION PROGRAM BY THE RISKS ASSOCIATED WITH THE ACTIVITIES COMPRISED THEREIN

(75) Inventors: Nurit ZELIG, Bnei Brak (IL); Yehezkeel BEN ARTZI, Ra'anana (IL)

Correspondence Address: BROWDY AND NEIMARK, P.L.L.C.;624 NINTH STREET, NW, SUITE 300, WASHINGTON, DC, 20001-5303, US

(73) Assignee: G.P.V. PROCESSES ANALYSIS & SOLUTIONS LTD., Ra'anana (IL)

(21) Appl. No.: 12/542,071

(22) Filed: Aug. 17, 2009

(30) Foreign Application Priority Data
Aug. 21, 2008 (IL) 193,632

(51) Int. Cl. G06Q 10/00

(52) U.S. Cl. 705/301

(57) ABSTRACT

A method is provided for managing a transition period during which a software application is changed by carrying out a transition program that comprises a plurality of activities, each associated with a risk factor representing a risk of a failure to carry out the transition program if the associated activity is not timely completed.

### FIELD OF THE INVENTION

The present invention relates to a method for program management, and in particular, to the management of programs and/or projects where the programs and/or projects are characterized by being associated with relatively high level of risk.

### BACKGROUND OF THE INVENTION

The ever-growing complexity of integrated tasks being handled nowadays by the industry, increases the risk that in such complex processes, certain steps will not be carried out as planned, a failure which in turn might have an adverse effect upon the performance of the whole program.

Furthermore, when considering a complex task such as replacing a company's IT application on which it relies for its entire operation would turn such a company exposed to critical business mal-functioning at times when there is a need to upgrade such applications. Not only that all of the commercial data of such a company is associated with the old applications, but also these applications might be interconnected, and a replacement of one application might result in catastrophic results for a user of other applications which have been retrieving data from the old application in order to use the other applications. At the same time, there is a growing rate at which these applications have to be replaced with new ones, ones that are more powerful, offer more features to the user and/or to the organization etc. It is therefore very clear that such organizations become increasingly exposed to failures that might occur during transition periods, where the organization shifts from one software application to another. Similar problems arise when a company decides to replace/modify its business process(es) (e.g. when changing its supply chain operation mode etc.). One of the major factors that have to be managed properly to minimize such exposure, is the risk involved with the various activities that comprise the overall mission.

Typically, such a mission may be composed from hundreds of activities to be assigned to tenths of the company users, the individual activities may be planned for few hours/minutes only, each activity can present different risk to the company, risk factors and causes intend to change frequently and as the period for executing the mission lasts longer, the risk factors and the risky activities might vary many times.

Under such conditions it is usually very difficult to track each activity status and establish its status e.g. whether it progresses according to plan, is it due on time, has it already accumulated a delay, what is the current risk that such a delay might have on the company, etc.

Managing hundreds of activities in such an environment while using the currently existing tools, becomes an impossible mission. Consequently, the mission itself could be well thought of and planned, but the overall result could be poor due to the lack of ability to manage the various activities while assessing the current existing risks and their influence on the “big picture”.

In view of the foregoing considerations, there is a need for a well defined tool that will enable the manager and the company management to manage the risks involved in carrying out a complex process such as transition plans of different types.

### SUMMARY OF THE INVENTION

It is an object of the present invention to provide a method to determine updated risks associated with individual program activities while enabling assessing the overall risk to the program which results from the updated individual risks.

It is another object of the present invention to provide a tool for managing the individual program activities while ensuring that the aggregated risk involved with these various activities does not exceed a pre-defined risk level for carrying out the program.

It is another object of the invention to provide a method to assist organization's management to get a full visibility of the updated risks while the program is being executed.

It is yet another object of the invention to provide a computer readable medium storing a computer program for determining updated risks associated with individual transition program activities while enabling assessing the overall risk to the program which results from the updated individual risks.

Other objects of the present invention will become more apparent from the following detailed description of the invention taken together with the accompanying examples and appended claims.

In accordance with a first embodiment of the present invention there is provided a method for use in managing transition period during which at least one software application is changed by carrying out a transition program or a project that comprises a plurality of activities each associated with a risk factor representing a risk of failure to carry out the transition program if a respective activity is not timely completed. The method comprises the steps of:
(i) preparing a plan for carrying out the transition program;
(ii) listing a plurality of activities comprised in the plan;
(iii) defining for each of the plurality of activities:
   i. a starting date;
   ii. duration;
   iii. expected completion date;
   iv. other activities (if exist) which depend upon completion of each of the plurality of activities;
   v. risk potential for the company in case of a failure to timely complete the associated activity, whether expressed quantitatively (having $ value to the failure) or relatively to other risks (e.g. high, low, etc.); and
(iv) providing a visual representation of various activities comprised in the program and a risk potential associated with each of the activities presented.

The term “software application” as used herein and in the claims, should be understood to encompass certain software or a part thereof that is a candidate for change/replacement whether by a newer version or by a completely different software as well as to encompass business process that is a candidate for a change/replacement.

As will be appreciated by those skilled in the art, although the specification and claims describe the present invention in connection with carrying out a software application replacement program in a company, it should be understood to encompass also managing a project which comprises a plurality of activities, mutatis mutandis.

Preferably, the step of providing a visual representation comprises calculating by one or more computer processors a risk potential associated with each of the various activities comprised in the program and presenting the calculated risk potential at display means.

According to an embodiment of the present invention, the risk potential associated with at least one of the plurality of activities is time dependent, i.e. its value would change the longer is the delay in completing the associated activity.

In accordance with another embodiment of the invention, the risk potential associated with at least one of the plurality of activities is dependent upon customer related factors.

According to another aspect of the invention there is provided a computer readable medium storing a computer program for performing a set of instructions to be executed by one or more computer processors, the computer program comprising the steps of:
(i) enabling input of a plan for carrying out a transition program for managing a transition period during which at least one software application is changed by carrying out the transition program, wherein the transition program comprises a plurality of activities each associated with a risk factor representing a risk of failure to carry out the transition program if a respective activity is not timely completed;
(ii) enabling input of a plurality of activities comprised in the plan;
(iii) enabling input of the following characterizing features for each of the plurality of activities:
   i. a starting date;
   ii. duration;
   iii. expected completion date;
   iv. other activities (if exist) which depend upon completion of each of the plurality of activities;
   v. risk potential for the company in case of a failure to timely complete the associated activity, whether expressed quantitatively (having $ value to the failure) or relatively to other risks (e.g. high, low, etc.); and
(iv) providing a visual representation of various activities comprised in the transition program and a risk potential associated with each of the activities presented.

### BRIEF DESCRIPTION OF THE DRAWINGS

FIG. 1—presents schematically the major steps in carrying out a process of changing software application/business model in accordance with an embodiment of the present invention; and

FIG. 2—is an illustration of a computer screen shot example, providing a visual representation of a result obtained while following an embodiment of the present invention.

### DETAILED DESCRIPTION OF THE INVENTION

A better understanding of the present invention may be obtained from the following non-limiting detailed description.

### Example

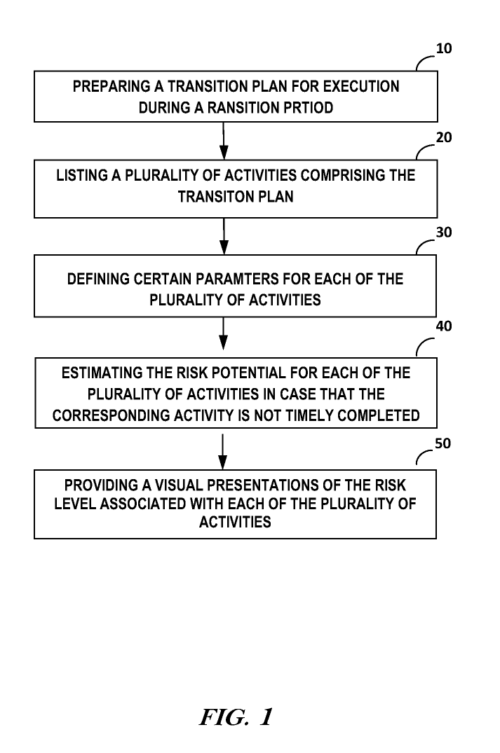

FIG. 1 exemplifies in a schematic way the major steps in carrying out a process the company A has undergone while installing a new software application called Enterprise Resource Planning (“ERP”). The company can undergo a similar process if it were to change one or more of its business processes. To do so, the method provided by the present invention was carried out in accordance with the following steps:
1) a transition plan for execution during the transition period was prepared (step 10);
2) a plurality of activities which comprise the transition plan was listed (step 20);
3) for each of the activities, the following parameters were defined (step 30):
   3.1 a starting date;
   3.2 duration; and
   3.3 expected completion date.

Next, the risk potential for the company was estimated (step 40) in case that the corresponding activity would not be completed in time, taking into account the following;

a. expected completion percentage of the activity as a function of time (when the completion percentage on the expected starting date is equal to zero and the completion percentage at the expected completion date is equal to 100%); and

b. customers' related concerns associated with each of the activities.

Based on the above, the risk potential was estimated for each of the activities. For any specific activity for which the risk potential was likely to change in course of time, i.e. the longer the delay in completion the task was, the higher was the risk potential to the company, the risk potential was estimated while including that time dependency.

The decision to be taken for the risk level of the program is based on assessing the aggregation of the various risks involved in the individual activities. Such a decision can be made based on any applicable model that would fit the user requirements. For example, the percentage of high level risk activities out of the overall number of open activities to complete the program. It may be based on the absolute number of activities that are defined as high risk activities, e.g. the program is considered to be a high risk program if it comprises more than x individual activities that are defined as high risk activities. Alternatively, a program might be considered a high risk program is the total value of damages that might be incurred in case of a failure in timely carrying out the individual activities, is higher than a pre-defined allowable value of potential risk as defined by the company.

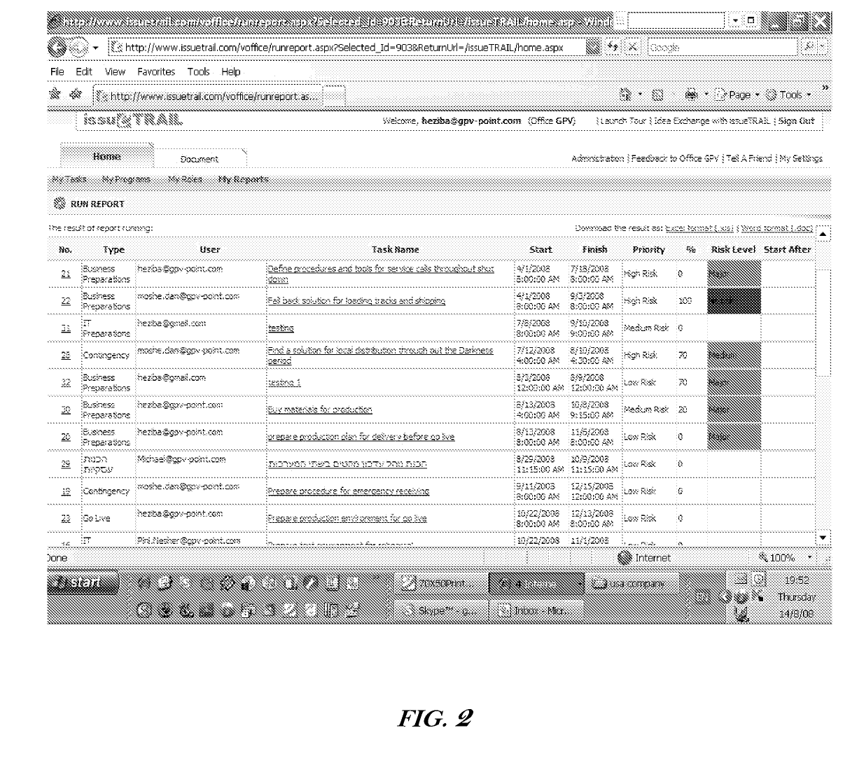

Once the risk potential of the various activities was estimated, a visual representation was provided (step 50) to the program manager where the level of the risk potential was indicated by using different colors. For example, for the highest risk potential activities, the risk potential associated with such an activity was indicated by having a square next to the activity in the list of activities that was colored in deep red and marked “major”. On the other hand for those activities that were associated with no risk potential, the indicating square was either left blank (for activities that do not influence the stream of activities at this point of time, hence cannot present a risk to the fulfilling of the program) or was colored in green (for activities that do not currently present a risk to the company, e.g. activities which were already completed, activities that proceed according to plan, etc.). Thus by glancing through the visual representation (as illustrated in FIG. 2), the program manager was able to identify the highest level risk activities and relate to them specifically, thereby enabling to manage the program as a risk based managed program.

As will be appreciated by those skilled in the art, the examples provided illustrate some ways of establishing a risk based management. However, similar methods may be used to achieve that goal, without departing from the scope of the present invention.

It is to be understood that the above description only includes some embodiments of the invention and serves for its illustration. Numerous other ways of carrying out the methods provided by the present invention may be devised by a person skilled in the art without departing from the scope of the invention, and are thus encompassed by the present invention.

1. A method for use in managing a transition period during which at least one software application is changed by carrying out a transition program that comprises a plurality of activities each associated with a risk factor representing a risk of failure to carry out the transition program if a respective activity is not timely completed, said method comprises the steps of:
(i) preparing a plan for carrying out the transition program;
(ii) listing a plurality of activities comprised in the plan;
(iii) for each of the plurality of activities, defining:
i. a starting date;
ii. duration;
iii. expected completion date;
iv. other activities which depend upon completion of each of the plurality of activities;
v. risk potential for the company in case of a failure to timely complete the associated activity; and
(iv) providing a visual representation of various activities comprised in said transition program and a risk potential associated with each of the activities presented.

2. A method according to claim 1, wherein the risk potential associated with at least one of the plurality of activities is time dependent.

3. A method according to claim 1, wherein the risk potential associated with at least one of the plurality of activities is dependent upon customer related factors.

4. A method according to claim 1, wherein the step of providing a visual representation comprises calculating by one or more computer processors a risk potential associated with each of the various activities comprised in said transition program and presenting the calculated risk potential at one or more display means.

5. A computer readable medium storing a computer program for performing a set of instructions to be executed by one or more computer processors, the computer program comprising the steps of:
(i) enabling input of a plan for carrying out a transition program for managing a transition period during which at least one software application is changed by carrying out said transition program, wherein said transition program comprises a plurality of activities each associated with a risk factor representing a risk of failure to carry out the transition program if a respective activity is not timely completed;
(ii) enabling input of a plurality of activities comprised in the plan;
(iii) enabling input of the following data for each of the plurality of activities:
i. a starting date;
ii. duration;
iii. expected completion date;
iv. other activities which depend upon completion of each of the plurality of activities;
v. risk potential for the company in case of a failure to timely complete the associated activity; and
(iv) providing a visual representation of various activities comprised in the transition program and a risk potential associated with each of the activities presented.
